(19) United States
(12) Patent Application Publication
(10) Pub. No.: US 2008/0262922 A1
(43) Pub. Date: Oct. 23, 2008

(54) CONTENTS, TEASER ADVERTISEMENT GENERATING METHOD, AND CONTENT PROVIDING METHOD

(76) Inventors: Kyung Hwan AHN, Daegu Metropolitan City (KR); Chun Woo Lee, Gumi-si (KR); Young Jae Choi, Gumi-si (KR); Young Il Nam, Gumi-si (KR); Na Kyung Kim, Gumi-si (KR)

Correspondence Address: CHA & REITER, LLC, 210 ROUTE 4 EAST STE 103, PARAMUS, NJ, 07652, US

(21) Appl. No.: 12/038,863

(22) Filed: Feb. 28, 2008

(30) Foreign Application Priority Data
Apr. 18, 2007 (KR) 2007-0037885

(51) Int. Cl. G06Q 30/00; G06F 12/00; G06F 17/30

(52) U.S. Cl. 705/14; 707/205; 707/2; 705/26; 707/E17.032

(57) ABSTRACT

The present invention relates to digital rights management (DRM) contents having a teaser section, a method for generating a teaser advertisement and a method for providing content. Data in the teaser section of a DRM content can be played without a license. A teaser advertisement can be easily created for a DRM content using the teaser section. The present invention can be applied to advertisement for and distribution of both DRM-protected contents and unprotected contents.

### CLAIMS OF PRIORITY

This application claims priority to an application entitled “CONTENTS, TEASER ADVERTISEMENT GENERATING METHOD, AND CONTENT PROVIDING METHOD,” filed in the Korean Intellectual Property Office on Apr. 18, 2007 and assigned Serial No. 2007-0037885, the entire contents of which are incorporated herein by reference.

### BACKGROUND OF THE INVENTION

1. Field of the Invention

The present invention relates generally to digital contents and, more particularly, to contents having a header zone including teaser section setting information, to a method enabling generation of teaser advertisements even for play-restricted contents using the teaser section setting information, and to a content-providing method enabling efficient distribution of the teaser advertisements.

2. Description of the Related Art

Digital rights management (DRM) relates to protection and management of copyrighted digital contents. Using cryptography, DRM aims to achieve secure delivery of various contents from content providers to users, and to prevent unauthorized redistribution of contents delivered to users. DRM supports the full life cycle of digital contents including creation, distribution, usage and retirement both in on-line and off-line states on the basis of the rights of users.

To use a DRM-protected content (or DRM content) in a mobile terminal, the user of the mobile terminal connects to a DRM content server and downloads a desired DRM content, metadata on the DRM content, and a license. The metadata provides information describing at least one attribute of the DRM content. The license contains a decryption key for decryption of the encrypted DRM content, and states usage rights upon the DRM content (for example, the number of plays and expiration dates). After download of the DRM content with the associated metadata and license in the mobile terminal, the user can use the downloaded DRM content within the usage rights stated in the license.

For example, if the license states the allowed number of plays, the user can play the DRM content only when the number of plays is less than the allowed number of plays. If the license states a usage duration, the user can use the DRM content only within the usage duration. If the license places restrictions on transmission, transmission of the DRM content to another mobile terminal is not allowed. Even if the DRM content is transmitted, the other mobile terminal cannot play the received DRM content.

However, the user cannot play a DRM content without a paid license. This may force the user to decide whether to buy a DRM content without detailed information on the DRM content. In particular, if a DRM content is a new movie not yet released or a new song, the problem of making a buying decision without detailed information becomes more serious. These circumstances may weaken customer's buying intentions, and cause significant damage to content providers. Consequently, it would be advantageous to develop a means that enables the user to make a decision to buy a DRM content with a minimal amount of information about the DRM content under consideration by the user.

### SUMMARY OF THE INVENTION

The present invention provides a content having a header zone and a content zone, a method for generating a teaser advertisement generating based on the content, and a content-providing method using a teaser advertisement generated by the teaser advertisement generating method.

In accordance with an embodiment of the present invention, there is provided a content, the content composed of a content zone for storing data and a header zone for defining the content zone, including: teaser section setting information in the header zone for defining a portion of the content zone to be extractable and a teaser section allocated in the content zone on the basis of the teaser section setting information.

In accordance with another embodiment of the present invention, there is provided a method for generating a teaser advertisement for contents having a content zone for storing data and a header zone for defining the content zone, including the steps of: extracting teaser section setting information that defines a teaser section in the content zone from the header zone of a content; extracting data from the teaser section on the basis of the extracted teaser section setting information; creating teaser header information defining the teaser section; and creating a teaser advertisement as a combination of the teaser header information and the data extracted from the teaser section.

In accordance with another embodiment of the present invention, there is provided a method for providing content, using contents having a content zone for storing data and a header zone for defining the content zone, including: receiving a teaser advertisement that is created using data extracted from the content zone of a selected content; deciding whether to download a content related to the teaser advertisement; if a decision is made to download a content, performing the steps of (1) connecting to a content-providing server, and (2) downloading the content related to the teaser advertisement from the content providing server.

In accordance with another embodiment of the present invention, there is provided a method for providing content, using contents having a content zone for storing data and a header zone for defining the content zone, including: during reception of a content having a teaser section allocated so as to be extractable in the content zone, playing data extracted from the teaser section; deciding whether to download the content based on the played data; and if the decision is to download the content, downloading and storing the content.

### BRIEF DESCRIPTION OF THE DRAWINGS

The features and advantages of the present invention will be more apparent from the following detailed description taken in conjunction with the accompanying drawings, in which:

FIG. 1 illustrates a content format for teaser advertisement according to an embodiment of the present invention;

FIG. 2 illustrates a configuration of a content providing system according to another embodiment of the present invention;

FIG. 3 illustrates a configuration of a distribution server of the system of FIG. 2;

FIG. 4 illustrates a configuration of a mobile terminal of the system of FIG. 2;

FIG. 5 is a flow chart illustrating a method for generating a teaser advertisement generating, according to another embodiment of the present invention;

FIG. 6 is a flow chart illustrating a method for distributing a teaser advertisement, according to another embodiment of the present invention;

FIG. 7 is a sequence diagram illustrating a method for providing content, according to another embodiment of the present invention; and

FIG. 8 is a sequence diagram illustrating a method for providing content, according to a further another embodiment of the present invention.

### DETAILED DESCRIPTION OF THE PRESENT INVENTION

Hereinafter, embodiments of the present invention are described in detail with reference to the accompanying drawings. The same reference symbols identify the same or corresponding elements in the drawings. Detailed descriptions of constructions or processes known in the art may be omitted to avoid obscuring the invention in unnecessary detail. Particular terms may be defined to describe the invention in the best manner. Accordingly, the meaning of specific terms or words used in the specification and the claims should not be limited to the literal or commonly employed sense, but should be construed in accordance with the spirit of the invention. The description of the various embodiments is to be construed as exemplary only and does not describe every possible instance of the invention. Therefore, it should be understood that various changes may be made and equivalents may be substituted for elements of the invention.

The description is focused on movie contents as examples of digital rights management (DRM) contents, however the present invention is not limited thereto. DRM contents may be related to content selected from the group consisting of movies, songs, broadcasts, and documents. Further, contents of the present invention may be any contents that can be protected by play rights.

The mobile terminal of the present invention is a terminal that can connect to a DRM content-providing server and preferably operate through short-range communication such as Bluetooth and Wi-Fi or through a mobile communication system, and may be any information and communication appliance or multimedia appliance selected from the group consisting of a mobile communication terminal, digital broadcast receiving terminal, personal digital assistant (PDA), smart phone, portable Internet terminal, high-speed downlink packet access (HSDPA) terminal, international mobile telecommunications 2000 (IMT 2000) terminal, wideband code division multiple access (WCDMA) terminal, and universal mobile telecommunications system (UMTS) terminal.

Contents of the present invention can be related to various data and information selected from the group consisting of movies, songs, and user-generated contents (UGC), and DRM-protected contents.

FIG. 1 illustrates a content format for teaser advertisement according to an exemplary embodiment of the present invention. The content format may be applicable to both unprotected contents and DRM-protected contents.

Referring to FIG. 1, a DRM content of DRM_MO includes a header zone and a content zone.

The header zone defines the content zone, and stores information regarding the content zone, including content size, content title, content creation time, content play duration, content file type, and content details.

In particular, the header zone includes teaser section setting information, which indicates a section of the content zone that is accessible without an associated license of DRM_RO. For example, in the case of a movie content, the teaser section setting information defines a frame interval or play interval of the content zone that can be accessed and extracted without an associated license of DRM_RO. Hence, the user can play a section defined by the teaser section setting information, and edit data in the defined section. When a teaser advertisement T_ads is created, the teaser section setting information can be included in teaser header information. That is, the teaser section setting information is converted into the size and play duration of the teaser section, and can be included in the teaser header information as detailed teaser section information.

The content zone is defined by the header zone, and stores playable content data. In the case of a movie content, the content zone comprises sections at which playable frames are stored.

In particular, the content zone includes a teaser section. That is, the content zone includes a teaser section that is defined by the teaser section setting information in the header zone. The teaser section is defined on and within the content zone in an overlapping manner. The teaser section may be divided into smaller portions, which are then distributed over the content zone. For example, in the case of a movie having multiple highlights, the content zone can include multiple teaser sections, each of which stores a portion of one of the highlights of the movie.

The DRM content of the present embodiment enables playing and extraction of a portion of the content zone without an associated license. The teaser section in the content zone is defined by the teaser section setting information in the header zone. Thus, the DRM content enables creation of an advertisement using the teaser section in the content zone without addition of a separate sample interval.

Although the content for teaser advertisement is described as a DRM-protected content, the present invention is not limited to a DRM-protected content. That is, teaser advertisements can also be created and distributed for unprotected contents according to the present invention. Therefore, the header zone of an unprotected content can include teaser section setting information defining a teaser section in the content zone. A distribution server or mobile terminal can check the header zone, extract teaser section setting information, read and edit the teaser section using the extracted teaser section setting information, and create a teaser advertisement. Thus, for an unprotected content, the distribution server or mobile terminal can readily create a teaser advertisement on the basis of teaser section setting information, and transmit the created teaser advertisement to another mobile terminal. The teaser section can be set according to intentions of the content author or developer. For example, a teaser section may be set so as to correspond to a portion of the highlight or climax of a movie.

Hereinabove, the format of a DRM content is described. Next, a system for creating and distributing teaser advertisements and for providing DRM contents is described.

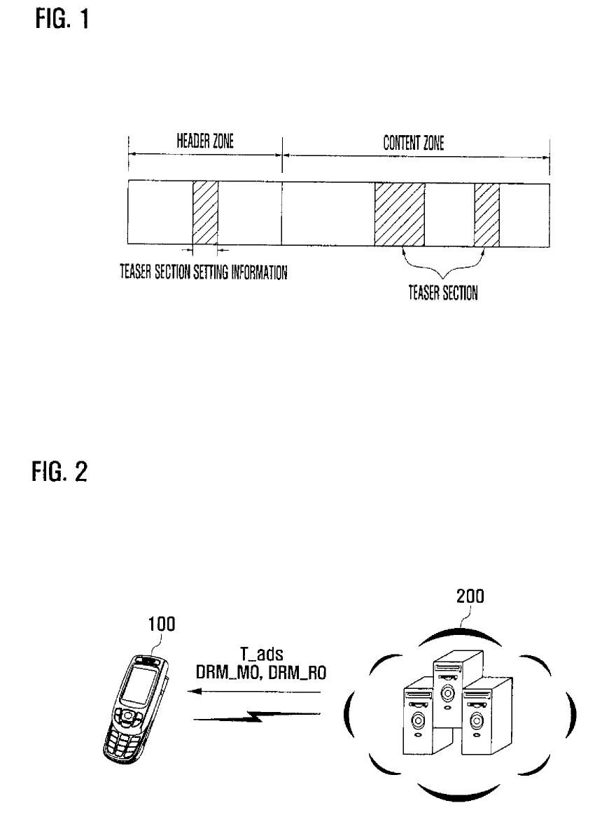

FIG. 2 illustrates a configuration of a content-providing system according to another exemplary embodiment of the present invention. For the purpose of description, the DRM content processed by the content-providing system is related to a movie content. However, the present invention is not limited to movie contents, and may also be applied to various types of contents including a movie content, music content, broadcast content, and document content.

Referring to FIG. 2, the content providing system includes a distribution server 200, and a mobile terminal 100. The distribution server 200 supplies a DRM content DRM_MO, a license DRM_RO necessary to play the DRM content DRM_MO, and a teaser advertisement T_ads. The mobile terminal 100 downloads the teaser advertisement T_ads, DRM content DRM_MO, and license DRM_RO from the distribution server 200. The content providing system can generate a teaser advertisement T_ads on the basis of the teaser section of a DRM content DRM_MO, and sends the generated teaser advertisement T_ads to the mobile terminal 100. Thus, the user of the mobile terminal 100 can view or listen to the teaser advertisement T_ads containing partial details of the DRM content DRM_MO without paying for the license DRM_RO. The content-providing system may further include a communication network for data transmission between the distribution server 200 and the mobile terminal 100. If the mobile terminal 100 is a mobile communication terminal, the communication network comprises a mobile communication system and support the wireless application protocol (WAP). The following description is focused on DRM contents requiring license purchase, however the present invention is not limited thereto. For an unprotected content, the user of the mobile terminal 100 can download the content without a separate payment and authentication procedure after viewing or listening to a teaser advertisement of T_ads.

The distribution server 200 creates a corresponding at least one teaser advertisement of T_ads using the at least one DRM content of DRM_MO, and provides the at least one teaser advertisement of T_ads to the mobile terminal 100 in response to a request from the mobile terminal 100. That is, when the at least one DRM content of DRM_MO is obtained, the distribution server 200 checks the header zone of the at least one DRM content of DRM_MO to find a teaser section setting information. The distribution server 200 extracts data from the teaser section in the content zone of the at least one DRM content of DRM_MO on the basis of the found teaser section setting information, and converts the data extracted from the teaser section into a corresponding at least one teaser advertisement of T_ads and stores the created at least one teaser advertisement of T_ads. The distribution server 200 can transmit the at least one DRM content of DRM_MO to the mobile terminal 100. The distribution server 200 can also transmit a license of DRM_RO for the at least one DRM content of DRM_MO to the mobile terminal 100 in response to a request from the mobile terminal 100.

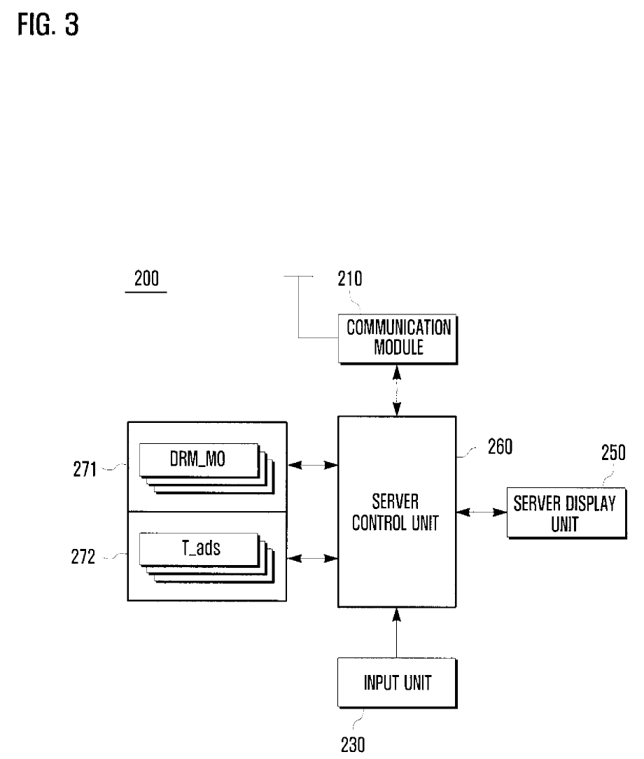

FIG. 3 illustrates a configuration of the distribution server 200 of the content-providing system of FIG. 2.

Referring to FIG. 3, the distribution server 200 includes a first storage unit 271 for storing the at least one DRM content of DRM_MO, a second storage unit 272 for storing the corresponding at least one teaser advertisement of T_ads for the at least one DRM content of DRM_MO, a communication module 210 for establishing a communication channel to the mobile terminal 100, a server display unit 250 for playing the at least one DRM content of DRM_MO and the corresponding at least one teaser advertisement of T_ads and for displaying a list of the at least one DRM content of DRM_MO and each corresponding teaser advertisement of T_ads, a server control unit 260 for controlling signal exchange between configuration elements and for creating at least one teaser advertisement of T_ads using at the least one content of DRM content of DRM_MO, and an input unit 230.

The first storage unit 271 stores the at least one DRM content of DRM_MO. The at least one DRM content of DRM_MO may include a plurality of content categories such as movies, songs, broadcasts, and documents. Preferably, the at least one DRM content of DRM_MO is stored in a database according to its categories. A category comprises subcategories. For example, the at least one DRM content of DRM_MO can be categorized as at least one movie content, song content, broadcast content, and document content. A movie content can be further categorized according to subcategories such as suspense, horror, and comic. Similarly, a song content, a broadcast content, and a document content comprises further broken down according to respective subcategories.

The second storage unit 272 stores the corresponding at least one teaser advertisement of T_ads created using the at least one DRM content of DRM_MO. Preferably, a teaser advertisement of T_ads stored in the second storage unit 272 has a link to the corresponding DRM content of DRM_MO stored in the first storage unit 271, to facilitate a purchase of a license for the corresponding DRM content after a user views or listens to the at least one teaser advertisement of T_ads.

When the mobile terminal 100 connects to the distribution server 200, a list of the at least one DRM content of DRM_MO in the first storage unit 271 and the corresponding at least one teaser advertisement of T_ads in the second storage unit 272 can be displayed on the screen of the mobile terminal 100. The at least one teaser advertisement of T_ads stored in the second storage unit 272 can be broadcast to a plurality of mobile terminals in accordance with at least one distribution policy of the distribution server 200. The broadcast of the at least one teaser advertisement of T_ads can be further distributed among mobile terminals through ad-hoc networks therebetween. The broadcast of the at least one teaser advertisement of T_ads can also be delivered to individual mobile terminals though a mobile communication system. The broadcast of the at least one teaser advertisement of T_ads can be provided to at least one mobile terminal selected by the distribution server 200 in accordance with the at least one distribution policy thereof.

The communication module 210 establishes a communication channel to the mobile terminal 100. In and alternative embodiment, when the mobile terminal 100 is a mobile communication terminal, the communication module 210 includes a radio frequency unit. In a further alternative embodiment, when the communication channel is a short-range wireless channel, the communication module 210 includes a short-range wireless unit based on Bluetooth, ZigBee, or ultra wideband (UWB). In an alternative embodiment, the short-range wireless unit is a communication module of a sever that supplies at least one teaser advertisement of T_ads to an ad-hoc network formed by the mobile terminal.

The server display unit 250 displays the at least one DRM content of DRM_MO and the corresponding at least one teaser advertisement of T_ads under the control of the server control unit 260. The server display unit 250 also displays a list of the at least one DRM content of DRM_MO and a list of the corresponding at least one teaser advertisement of T_ads. The server display unit 250 provides a screen interface enabling a server manager to access the first storage unit 271 and second storage unit 272.

The server control unit 260 controls signal exchange between the components. In particular, the server control unit 260 creates a corresponding at least one teaser advertisement of T_ads using the at least one DRM content of DRM_MO, and stores the created at least one corresponding teaser advertisement of T_ads in the second storage unit 272. To create the at least one teaser advertisement of T_ads, the server control unit 260 selects one of all or part of an information in a header zone of the at least one DRM content of DRM_MO as a selected teaser header information. The server control unit 260 combines the selected teaser header information and a data extracted from the teaser section of the at least one DRM content of DRM_MO together to form the corresponding teaser advertisement of T_ads. The selected teaser header information comprises teaser section setting information. The server control unit 260 controls the server display unit 250 to display the at least one DRM content of DRM_MO and the corresponding at least one teaser advertisement of T_ads. When the mobile terminal 100 connects to the distribution server 200 through the communication module 210, the server control unit 260 provides the mobile terminal 100 with an access screen interface. The server control unit 260 performs procedures for delivering the at least one DRM content of DRM_MO to the mobile terminal 100, such as payment and authentication. After authentication and payment, the server control unit 260 delivers the at least one DRM content of DRM_MO and an associated license DRM_RO to the mobile terminal 100. In addition, depending upon the at least one distribution policy of the distribution server 200, the server control unit 260 can broadcast the at least one teaser advertisements of T_ads, periodically or selectively, to any of the mobile terminal 100 and a network formed by the mobile terminal 100.

The input unit 230 generates an input signal for controlling the distribution server 200, and sends the generated input signal to the server control unit 260.

In the description, the distribution server 200 creates corresponding at least one teaser advertisement of T_ads for at least one DRM content of DRM_MO. However, the distribution server 200 also creates and distributes teaser advertisements of T_ads for unprotected contents. Therefor, the first storage unit 271 may store at least one unprotected content. The second storage unit 272 stores a corresponding at least one teaser advertisement of T_ads created using the at least one unprotected content. The server display unit 250 displays a list of the at least one unprotected contents, and a list of the corresponding at least one teaser advertisement of T_ads created for the at least one unprotected content.

The mobile terminal 100 connects to the distribution server 200, downloads the at least one teaser advertisement of T_ads, and displays the downloaded at least one teaser advertisement of T_ads to the user. To purchase the at least one DRM content of DRM_MO corresponding to the at least one teaser advertisement of T_ads, the user directs the mobile terminal 100 to connect to the distribution server 200 and perform an authentication and payment procedure together with the distribution server 200. After authentication and payment, the mobile terminal 100 downloads the paid for at least one DRM content of DRM_MO.

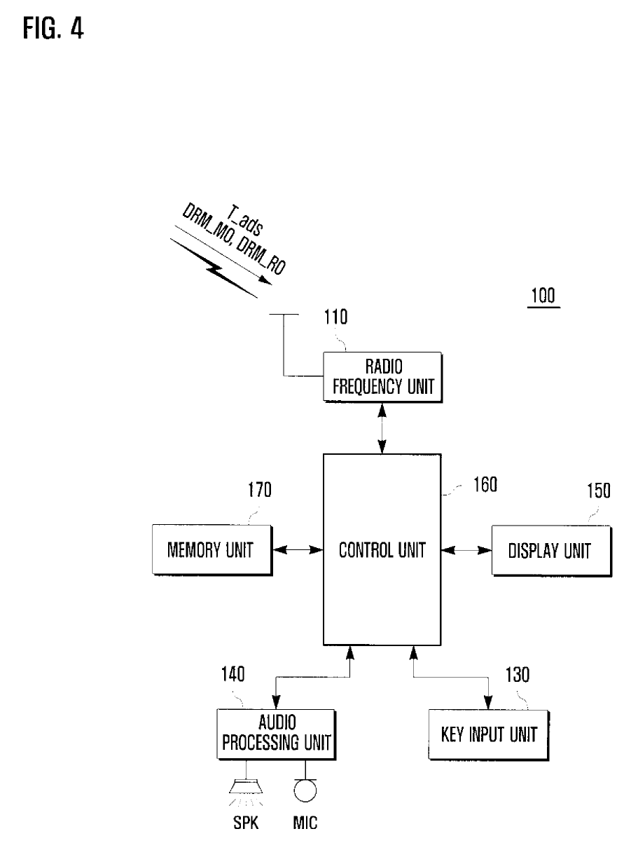

FIG. 4 illustrates a configuration of the mobile terminal 100 in a content-providing system.

Referring to FIG. 4, the mobile terminal 100 includes a memory unit 170, a key input unit 130, an audio processing unit 140, a display unit 150, a radio frequency unit 10, and a control unit 160.

The memory unit 170 stores a plurality of application programs necessary for the performance of functions of the present embodiment, a plurality of application programs that provide a plurality of screen interfaces, and a plurality of application programs that play the at least one DRM content of DRM_MO and the corresponding at least one teaser advertisement of T_ads. The memory unit 170 stores the at least one teaser advertisement of T_ads, the at least one DRM content of DRM_MO, and at least one license of DRM_RO necessary for playing the at least one DRM content of DRM_MO. The memory unit 170 includes a program memory section and a data memory section.

The program memory section stores an operating system for booting the mobile terminal 100, at least one application program for multimedia playing, and at least one application program for supplementary functions of the mobile terminal 100 related to, for example, playing audios, images and videos. In particular, the program memory section stores at least one application program for playing the at least one DRM content of DRM_MO. The at least one application program includes at least one plurality of player programs selected from the group consisting of audio and video player programs for movies and broadcasts, MP3 audio player programs for music, and viewer programs for documents.

The data memory section stores data generated during a use of the mobile terminal 100. For example, the data memory section stores the at least one teaser advertisements T_ads, DRM contents DRM_MO and licenses DRM_RO, downloaded from the distribution server 200. The data memory section can store the at least one teaser advertisement of T_ads corresponding to the at least one DRM content of DRM_MO and the at least one DRM content of DRM_MO according to their categories in a database format. For example, in the case of music contents stored in the data memory section, music files are categorized in terms of at least one category selected from the group consisting of album, genre, artist, and title. That is, music files include a plurality of audio tracks, and the audio tracks are categorized as a categorization information in terms of album, genres, artist, and title for easy selection for the user. The categorization information is stored in the data memory section, and can be displayed on the display unit 150 under the control of the control unit 160.

The key input unit 130 includes a plurality of alphanumeric and function keys for inputting alphanumeric information and setting various functions. The function keys include direction, side, and shortcut keys associated with particular functions. The key input unit 130 sends to the control unit 160 a key signal, generated by the user for setting and controlling operations of the mobile terminal 100.

In particular, the key input unit 130 generates a key signal for connecting to the distribution server 200, a key signal for receiving the at least one teaser advertisement of T_ads and the at least one DRM content of DRM_MO from the distribution server 200, and a key signal for selecting a file according to activation of an application for playing the selected at least one teaser advertisement of T_ads and the corresponding at least one DRM content of DRM_MO. The key input unit 130 generates a command signal (including, for example, play, fast forward, fast rewind, pause, or stop) for controlling playing of the at least one teaser advertisement of T_ads and the corresponding at least one DRM content of DRM_MO, and sends the command signal to the control unit 160.

The audio processing unit 140 reproduces an audio signal from the at least one teaser advertisement of T_ads and the corresponding at least one DRM content of DRM_MO through a speaker SPK, and sends an audio signal such as a voice signal from a microphone MIC to the control unit 160.

The display unit 150 displays various menus of the mobile terminal 100, information input by the user, and information to be provided to the user. In particular, the display unit 150 displays a screen for receiving the at least one teaser advertisement of T_ads from the distribution server 200, a screen for playing the at least one teaser advertisement T_ads and the corresponding at least one DRM content of DRM_MO, a screen for accessing the distribution server 200 to download the at least one DRM content of DRM_MO, and a screen for performing a payment and authentication procedure with the distribution server 200.

The control unit 160 controls the overall operation of the mobile terminal 100, and signal exchange between internal components of the mobile terminal 100. The control unit 160 may include a modulator/demodulator (modem) and a coder/decoder (codec).

In particular, the control unit 160 receives the at least one teaser advertisement of T_ads in response to a key signal from the key input unit 130, and controls a display operation to display the received at least one teaser advertisement of T_ads according to a user request. The control unit 160 controls a communication operation to connect to the distribution server 200 for downloading the at least one DRM content of DRM_MO corresponding to the displayed teaser advertisement of T_ads. The control unit 160 can create at least one teaser advertisement of T_ads in a manner similar to that of the distribution server 200.

The control unit 160 can control the communication operation to send a received at least one teaser advertisement of T_ads to another mobile terminal close to the mobile terminal 100. That is, the control unit 160 can broadcast a received at least one teaser advertisement of T_ads to other mobile terminals networked with the mobile terminal 100 through, for example, an ad-hoc network or Bluetooth piconet.

After reception of the at least one DRM content of DRM_MO, the control unit 160 can create a corresponding at least one teaser advertisement T_ads. That is, the control unit 160 detects a teaser section on the basis of teaser section setting information in the header zone of the at least one DRM content of DRM_MO, and converts data in the teaser section into at least one corresponding teaser advertisement of T_ads. Hence, the control unit 160 can create at least one teaser advertisement of T_ads for corresponding to the at least one DRM content of DRM_MO, and send the created at least one corresponding teaser advertisement of T_ads to another mobile terminal.

When an unprotected content is received from the distribution server 200, the control unit 160 of the mobile terminal 100 can create at least one teaser advertisement of T_ads for the unprotected content and send the created at least one teaser advertisement of T_ads to another mobile terminal. That is, the mobile terminal 100 checks the header zone of the unprotected content to find teaser section setting information. If teaser section setting information is found, the mobile terminal 100 can create at least one teaser advertisement of T_ads using the teaser section setting information.

In the content-providing system of the present embodiment, the distribution server 200 creates a corresponding at least one teaser advertisement of T_ads using at least one DRM content of DRM_MO and supplies the created at least one teaser advertisement of T_ads to the mobile terminal 100. Hence, creation of a separate sample advertisement is unnecessary. After reception of the at least one DRM content of DRM_MO, the mobile terminal 100 can independently create at least one teaser advertisement of T_ads corresponding to the received at least one DRM content of DRM_MO. Hence, advertising effectiveness can be enhanced. The content-providing system enables creation and distribution of at least one teaser advertisement of T_ads for each unprotected contents having a teaser section. Accordingly, the present invention can contribute to distribution and dissemination of various contents.

Hereinabove, the content-providing system is described. Next, methods of creating and distributing teaser advertisements are described.

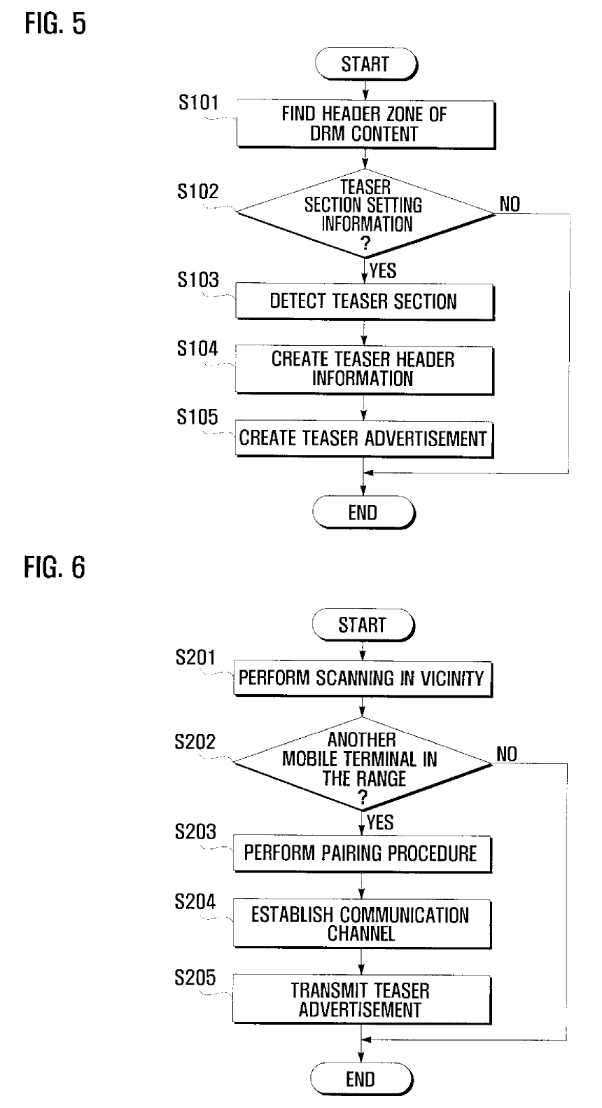

FIG. 5 is a flow chart illustrating a method for generating a teaser advertisement, according to another exemplary embodiment of the present invention. As described previously, the distribution server 200 and the mobile terminal 100 can create teaser advertisements of T_ads using DRM contents of DRM_MO independently of each other in the same manner. In the following description, the mobile terminal 100 creates a teaser advertisement of T_ads.

Referring to FIG. 5, the control unit 160 of the mobile terminal 100 finds a header zone of a selected DRM content of DRM_MO (S101), and checks the presence of a teaser section setting information in the header zone (S102). If the teaser section setting information is not present, the procedure ends because at least one teaser advertisement of T_ads cannot be created.

If the teaser section setting information is present in the header zone, the control unit 160 finds a teaser section in a content zone of the DRM content of DRM_MO on the basis of the teaser section setting information (S103). The teaser section can correspond to any of a frame and play interval in the content zone.

The control unit 160 creates at least one teaser header information corresponding to the teaser section (8104), and combines the created at least one teaser header information and data extracted from the teaser section together to create at least one teaser advertisement of T_ads (S105).

The teaser header information can be one of all and part of information in the header zone of the DRM content of DRM_MO. That is, the teaser header information can include a teaser advertisement type, creation date and time, actor information, content size, teaser advertisement size, and content play duration. In the case of a movie, the teaser header information can further include the release date.

The at least one teaser advertisement of T_ads is an advertisement for the sale of the at least one DRM content of DRM_MO, and is preferably made from a portion of the highlight in the at least one DRM content of DRM_MO. A corresponding at least one teaser advertisement of T_ads can be created for an unprotected content in addition to the at least one DRM content of DRM_MO. The user of the mobile terminal 100 or the distribution server 200 can edit an existing advertisement or movie having a relatively long play duration and create at least one teaser advertisement of T_ads having a relatively short play duration.

FIG. 6 is a flow chart illustrating a method for distributing at lest one of teaser advertisement according another exemplary embodiment of the present invention. In teaser advertisement distribution, the distribution server 200 and the mobile terminal 100 can distribute the at least one teaser advertisement of T_ads independently of each other in the same manner. In the following description, the mobile terminal 100 distributes the at least one teaser advertisement of T_ads. The mobile terminal 100 is assumed to form a Bluetooth network, however the present invention is not limited thereto. The mobile terminal 100 may distribute the at least one teaser advertisement of T_ads through various means including a wireless communication module, separate mobile communication system, and one-to-one communication. The mobile terminal 100 can broadcast the at least one teaser advertisement of T_ads over an ad-hoc network. As described previously, the method for distributing the at Least one teaser advertisement applies to both DRM-protected contents and unprotected contents.

Referring to FIG. 6, the control unit 160 of the mobile terminal 100 performs scanning through a communication module to find other devices in the vicinity (S201), and checks whether another mobile terminal capable of communications is present in the vicinity (S202).

If another mobile terminal is present, the control unit 160 performs a pairing procedure with the other mobile terminal (S203), and then establishes a communication channel to the other mobile terminal (S204). The communication channel may differ depending upon the properties of the at least one DRM content of DRM_MO, and is preferably an asynchronous connection-oriented channel in consideration of data communication.

The control unit 160 transmits at least one teaser advertisement of T_ads to the other mobile terminal through the established communication channel (S205).

In the case when the mobile terminal 100 forms an ad-hoc network, the mobile terminal 100 can broadcast at least one teaser advertisement of T_ads. That is, the mobile terminal 100 can packetize the at least one teaser advertisement of T_ads into IP packets, and broadcast the IP packets on the ad-hoc network using an IP broadcast address whose portion is set to “0000”, for example.

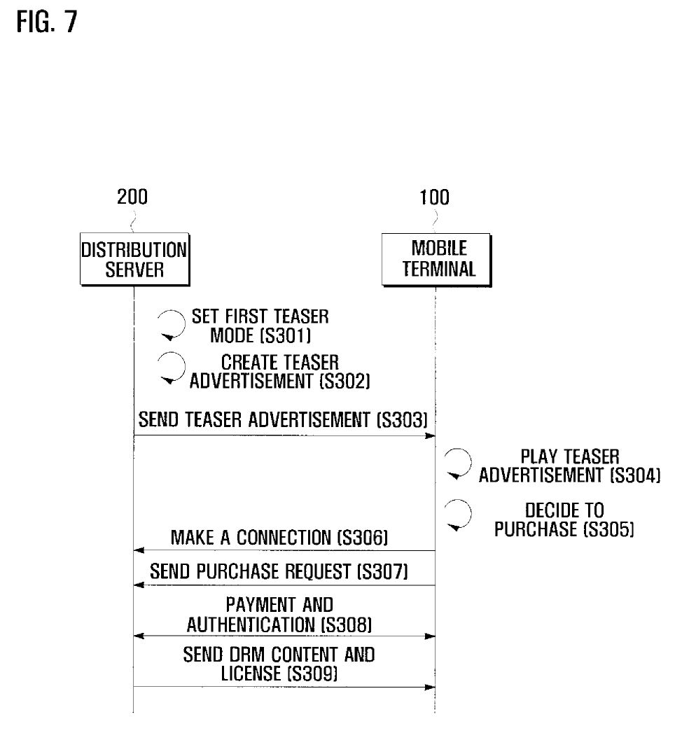

FIG. 7 is a sequence diagram illustrating a method for providing method content, according to another exemplary embodiment of the present invention.

Referring to FIG. 7, the distribution server 200 sets a first teaser mode (8301). In the first teaser mode, the distribution server 200 sends only at least one teaser advertisement of T_ads to the mobile terminal 100. The distribution server 200 extracts information in the teaser section of a selected at least one DRM content of DRM_MO and creates a corresponding at least one teaser advertisement of T_ads (S302), and transmits the created at least one teaser advertisement of T_ads to the mobile terminal 100 (S303). At step S302, the distribution server 200 creates teaser header information using information selectively extracted from the header zone of the at least one DRM content of DRM_MO, and combines the teaser header information and the data from the teaser section together to create the corresponding at least one teaser advertisement of T_ads.

The mobile terminal 100 receives and plays the at least one teaser advertisement of T_ads in a streaming manner (S304). The mobile terminal 100 requests the user to decide whether to purchase the at least one DRM content of DRM_MO (S305). If the user decides to purchase the at least one DRM content of DRM_MO, the mobile terminal 100 connects to the distribution server 200 (S306), and transmits a purchase request for the at least one DRM content of DRM_MO and an associated license of DRM_RO to the distribution server 200 (S307). The distribution server 200 and the mobile terminal 100 perform a payment and authentication procedure (S308). After payment and authentication, the mobile terminal 100 downloads the at least one DRM content of DRM_MO and associated license of DRM_RO (S309).

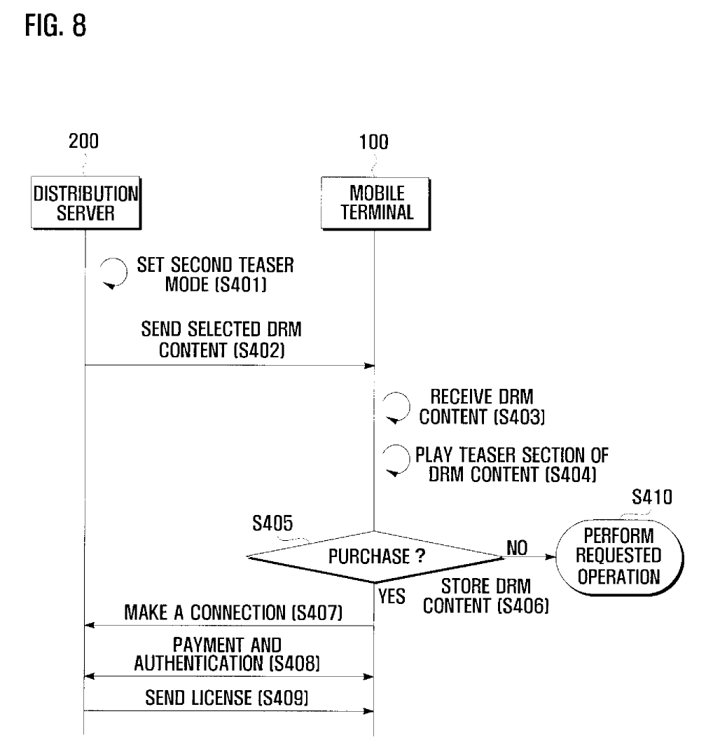

FIG. 8 is a sequence diagram illustrating a method for providing content providing, according to yet another exemplary embodiment of the present invention.

Referring to FIG. 8, the distribution server 200 sets a second teaser mode (S401), and sends a selected at least one DRM content of DRM_MO to the mobile terminal 100 (S402).

The mobile terminal 100 receives the at least one DRM content of DRM_MO (S403), and plays data in the teaser section of the received at least one DRM content of DRM_MO in a streaming manner (S404).

At step S402, the distribution server 200 sends first the teaser section of the at least one DRM content of DRM_MO to the mobile terminal 100 before sending other sections thereof for easy playback. Thus, the mobile terminal 100 can start to play the teaser section without awaiting reception of the whole at least one DRM content of DRM_MO. When the teaser section is arranged at the middle or end of the at least one DRM content of DRM_MO, the mobile terminal 100 can temporarily store the at least one DRM content of DRM_MO in a buffer space for playing of the teaser section.

The mobile terminal 100 requests the user to decide whether to purchase the at least one DRM content of DRM_MO (S405). If the user decides to purchase the at least one DRM content of DRM_MO, the mobile terminal 100 stores the at least one DRM content of DRM_MO (S406). Thereafter, the mobile terminal 100 connects to the distribution server 200 (S407). The mobile terminal 100 performs a payment and authentication procedure with the distribution server 200 (S408). After payment and authentication, the mobile terminal 100 downloads at least one license of DRM_RO associated with the least one DRM content of DRM_MO (S409).

If the user decides not to purchase the at least one DRM content of DRM_MO at step S405, the mobile terminal 100 does not store the at least one DRM content of DRM_MO and may remove the temporarily stored at least one DRM content of DRM_MO, if exists. The mobile terminal 100 continues a requested operation such as mobile communication, photographing, audio playing, and broadcast reception (S410).

As apparent from the above description, the present invention provides DRM contents having a teaser section, a method for generating a teaser advertisement, and a method for providing content. Data in the teaser section can be played without a license. A teaser advertisement can be readily created for a DRM content using the teaser section. The cost of developing a DRM content can be reduced because creation of a separate sample advertisement is unnecessary. For an unprotected content, teaser section setting information that enables the generation of a teaser advertisement can also be provided in the header zone. Hence, the present invention can be applied to advertisement for and distribution of both DRM-protected contents and unprotected contents.

While exemplary embodiments of the present invention have been shown and described in this specification, it will be understood by those skilled in the art that various changes or modifications of the embodiments are possible without departing from the spirit and scope of the invention as defined by the appended claims.

What is claimed is:

1. A content including a content zone for storing data and a header zone for defining the content zone, comprising:
a teaser section setting information in the header zone for defining a portion of the content zone to be extractable; and
a teaser section allocated in the content zone on the basis of the teaser section setting information.

2. The content of claim 1, wherein the content is a digital rights management (DRM) content.

3. The content of claim 2, wherein the teaser section is a section that is allocated in the content zone of the DRM content and playable without a license.

4. The content of claim 1, wherein the content zone comprises a plurality of teaser sections.

5. The content of claim 1, wherein the teaser section setting information has information on a frame interval, corresponding to the teaser section, in the content zone.

6. The content of claim 1, wherein the teaser section setting information has information on a play interval, corresponding to the teaser section, in the content zone.

7. The content of claim 1, wherein the content is selected from a group consisting of a movie content, a music content, a broadcast content, and a document content.

8. The content of claim 7, wherein the header zone comprises at least one information selected from the group consisting of a content zone size, a content title, a creation date and time, a content play duration, a content release date, a content file type, and a content details.

9. A method for generating at least one teaser for a content having a content zone that stores data and a header zone that defines the content zone, comprising:
extracting from the header zone of the content, teaser section setting information that defines a teaser section in the content zone;
extracting data from the teaser section on the basis of the extracted teaser section setting information;
creating teaser header information defining the teaser section; and
creating a teaser advertisement by combining together the teaser header information and the data extracted from the teaser section.

10. The method of claim 9, wherein the content is a digital rights management (DRM) content.

11. The method of claim 10, wherein the teaser section is a section that is allocated in the content zone of the DRM content and playable without a license.

12. The method of claim 9, wherein the header zone comprises information regarding at least item selected from the group consisting of a content zone size, a content title, a creation date and time, a content play duration, a content release date, a content file type, and a content details.

13. The method of claim 12, wherein creating teaser header information further comprises:
selecting a portion of information in the header zone;
extracting information on the teaser section from the teaser section setting information; and
combining together the portion of information selected from the header zone and the extracted information on the teaser section.

14. A method for providing content providing using contents having a content zone for storing data and a header zone for defining the content zone, comprising:
receiving a teaser advertisement that is created using data extracted from the content zone of a selected content;
deciding whether to download a content corresponding to the received teaser advertisement;
when it is decided to download the content corresponding to the received teaser advertisement, performing the steps of:
connecting to a content-providing server, and
downloading from the content-providing server the content corresponding to the teaser advertisement.

15. The method of claim 14, wherein the content is a digital rights management (DRM) content.

16. The method of claim 15, wherein the teaser advertisement is created on the basis of a teaser section that is allocated in the content zone of the DRM content and is playable without a license.

17. The method of claim 15, further comprising:
deciding whether to purchase the content related to the teaser advertisement;
if it is decided to purchase the content corresponding to the teaser advertisement, performing the steps of:
downloading a license for playing the content from the content-providing server according to the purchase decision, and
performing a payment and authentication procedure with the content-providing server.

18. The method of claim 14, further comprising creating the teaser advertisement by performing the steps of:
extracting teaser section setting information that defines a teaser section in the content zone from the header zone;
extracting data from the teaser section on the basis of the extracted teaser section setting information;
creating teaser header information defining the teaser section; and
combining together the teaser header information and the data extracted from the teaser section.

19. The method of claim 14, wherein the teaser advertisement is transmitted in a streaming manner.

20. A method for providing a content that uses contents having a content zone for storing data and a header zone for defining the content zone, comprising:
during reception of a content having a teaser section allocated so as to be extractable in the content zone, playing data extracted from the teaser section;
deciding whether to download the content; and
when it is decided to download the content, performing the steps of: and
downloading the content, and
storing the content.

21. The method of claim 20, wherein:
the content is a digital rights management (DRM) content; and
when it is decided to download the content, further comprising the steps of:
connecting to a content-providing,
downloading a license associated with the content from the content-providing server, and
performing a payment and authentication procedure with the content-providing server.

22. The method of claim 20, wherein the step of playing data from the teaser section further comprises the steps of:
examining the header zone of the DRM content and extracting teaser section setting information that defines a teaser section in the content zone;
detecting the teaser section on the basis of the extracted teaser section setting information; and
playing data extracted from the detected teaser section.

23. The method of claim 20, further comprising temporarily storing the content being received during playing of the data from the teaser section.

24. The method of claim 21, wherein the DRM content is transmitted in a streaming manner.
